(19) United States
(12) Patent Application Publication
(10) Pub. No.: US 2015/0194128 A1
(43) Pub. Date: Jul. 9, 2015

(54) GENERATING A LOW-LATENCY TRANSPARENCY EFFECT

(71) Applicant: Nvidia Corporation, Santa Clara, CA (US)

(72) Inventor: Gary D. HICOK, Mesa, AZ (US)

(73) Assignee: NVIDIA CORPORATION, Santa Clara, CA (US)

(21) Appl. No.: 14/149,648

(22) Filed: Jan. 7, 2014

(51) Int. Cl. G09G 5/12; G06T 19/00; G06T 1/00; G06T 5/50; G06T 11/00; H04N 5/235

(52) U.S. Cl. CPC G09G 5/12; G06T 11/001; H04N 5/2352; G06T 1/0007; G06T 5/50; G06T 19/006; G09G 2340/12; G09G 2340/14; G06T 2215/16; G06T 2200/28; G06T 2210/62

(57) ABSTRACT

One embodiment of the present invention sets forth a technique for generating a transparency effect for a computing device. The technique includes transmitting, to a camera, a synchronization signal associated with a refresh rate of a display. The technique further includes determining a line of sight of a user relative to the display, acquiring a first image based on the synchronization signal, and processing the first image based on the line of sight of the user to generate a first processed image. Finally, the technique includes compositing first visual information and the first processed image to generate a first composited image, and displaying the first composited image on the display.

### BACKGROUND OF THE INVENTION

1. Field of the Invention

Embodiments of the present invention generally relate to graphics processing and, more specifically, to generating a low-latency transparency effect.

2. Description of the Related Art

Display devices are widely used in a variety of electronic systems to provide visual information to a user. For example, a display device may be used to provide a visual interface to the user of a desktop computer. In addition, advancements in display technologies have enabled display devices to be incorporated into a number of mobile applications, such as laptop computers, tablet computers, and mobile phones. In such applications, display devices are capable of providing high-resolution interfaces that are capable of accurately reproducing a wide color gamut.

Electronic systems having larger displays generally provide a more immersive user-experience. However, a large display may obstruct a user's field of view, interfering with the user's ability to effectively interact and communicate with others or pay attention to the surrounding environment while viewing information on the larger display. Additionally, in mobile display applications, obstructing a user's field of view with a display device may interfere with the user's ability to navigate his or her surroundings. As a result, viewing a mobile display device while walking may result in injury to the user or to those nearby the user.

To address the above shortcomings, conceptual product designs often portray electronic devices that are made of transparent materials, enabling a user to see objects behind a display while viewing information on the display. In addition, such conceptual designs commonly depict the ability to implement augmented reality techniques, which overlay relevant information when a user's surroundings are viewed through the transparent display device. Unfortunately, the transparent electronic devices depicted in conceptual product designs generally are based on technologies and materials that are not yet commercially available and/or which do not yet exist. By contrast, in conventional electronic devices, techniques such as augmented reality typically are performed by projecting an image captured by the device's rear-facing camera onto a display device. However, conventional electronic devices typically exhibit a significant amount of latency associated with processing and displaying images captured by the rear-facing camera. This latency may significantly detract from the user experience when an end-user is attempting to interact with his or her surroundings in real-time.

Accordingly, there is a need in the art for an improved way of effecting a transparent display device.

### SUMMARY OF THE INVENTION

One embodiment of the present invention sets forth a method for generating a transparency effect for a computing device. The method includes transmitting, to a camera, a synchronization signal associated with a refresh rate of a display. The method further includes determining a line of sight of a user relative to the display, acquiring a first image based on the synchronization signal, and processing the first image based on the line of sight of the user to generate a first processed image. Finally, the method includes compositing first visual information and the first processed image to generate a first composited image, and displaying the first composited image on the display.

Further embodiments provide, among other things, a computing device and a non-transitory computer-readable medium configured to carry out method steps set forth above.

Advantageously, the disclosed technique enables a display device to be configured to simulate a transparency effect in real-time. Additionally, the disclosed technique enables the transparency effect to be modified based on changes to the point of view of the user relative to the display device to provide the user with a continuous line of sight through the display device. Accordingly, the user is able to more efficiently view information on the display device while also viewing and interacting with objects that would otherwise be obscured by the display device.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of the GPU 112 of FIG. 1, according to one embodiment of the present invention;

FIG. 3A illustrates a conventional technique for processing an image acquired by a camera;

FIG. 3B illustrates a technique for processing an image acquired by a camera to generate a transparency effect, according to one embodiment of the present invention;

FIGS. 4A-4F are conceptual diagrams of transparency effects produced by the technique of FIG. 3B, according to various embodiments of the present invention; and

FIG. 5 is a flow diagram of method steps for generating a transparency effect for a computing device, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

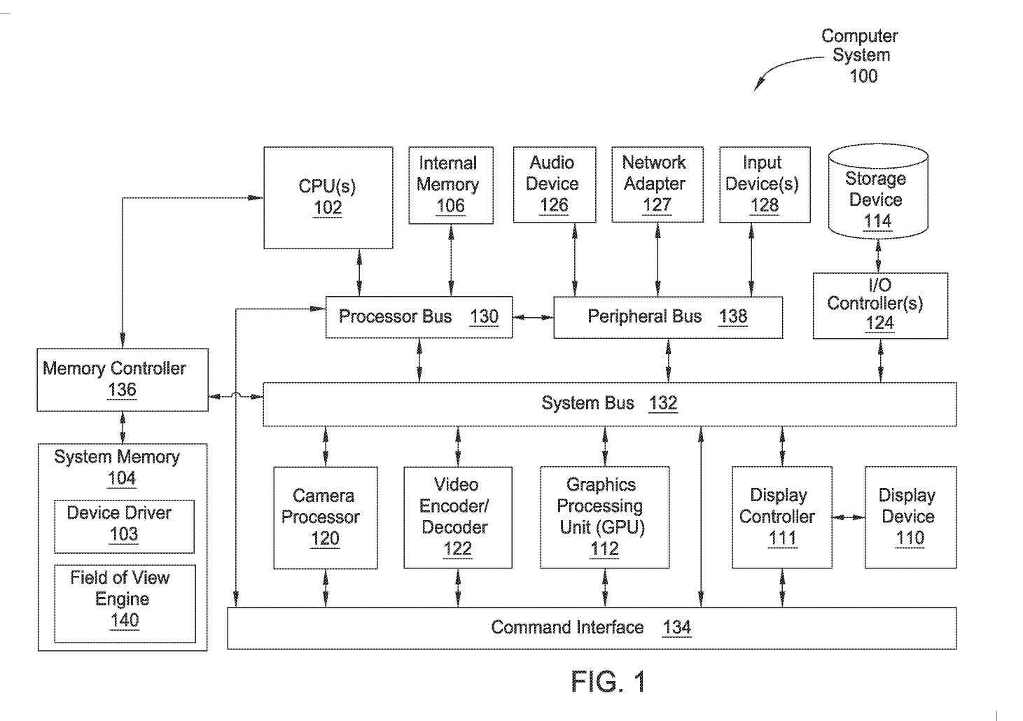

FIG. 1 is a block diagram illustrating a computer system 100 configured to implement one or more aspects of the present invention. As shown, computer system 100 includes, without limitation, one or more central processing units (CPUs) 102 coupled to a system memory 104 via a memory controller 136. The CPU(s) 102 may further be coupled to internal memory 106 via a processor bus 130. The internal memory 106 may include internal read-only memory (IROM) and/or internal random access memory (IRAM). Computer system 100 further includes a processor bus 130, a system bus 132, a command interface 134, and a peripheral bus 138. System bus 132 is coupled to a camera processor 120, video encoder/decoder 122, graphics processing unit (GPU) 112, display controller 111, processor bus 130, memory controller 136, and peripheral bus 138. System bus 132 is further coupled to a storage device 114 via an I/O controller 124. Peripheral bus 138 is coupled to audio device 126, network adapter 127, and input device(s) 128.

In operation, the CPU(s) 102 are configured to transmit and receive memory traffic via the memory controller 136. The CPU(s) 102 are also configured to transmit and receive I/O traffic and communicate with devices connected to the system bus 132, command interface 134, and peripheral bus 138 via the processor bus 130. For example, the CPU(s) 102 may write commands directly to devices via the processor bus 130. Additionally, the CPU(s) 102 may write command buffers to system memory 104. The command interface 134 may then read the command buffers from system memory 104 and write the commands to the devices (e.g., camera processor 120, GPU 112, etc.). The command interface 134 may further provide synchronization for devices to which it is coupled.

The system bus 132 includes a high-bandwidth bus to which direct-memory clients may be coupled. For example, I/O controller(s) 124 coupled to the system bus 132 may include high-bandwidth clients such as Universal Serial Bus (USB) 2.0/3.0 controllers, flash memory controllers, and the like. The system bus 132 also may be coupled to middle-tier clients. For example, the I/O controller(s) 124 may include middle-tier clients such as USB 1.x controllers, multi-media card controllers, Mobile Industry Processor Interface (MIPI®) controllers, universal asynchronous receiver/transmitter (UART) controllers, and the like. As shown, the storage device 114 may be coupled to the system bus 132 via I/O controller 124. The storage device 114 may be configured to store content and applications and data for use by CPU(s) 102, GPU 112, camera processor 120, etc. As a general matter, storage device 114 provides non-volatile storage for applications and data and may include fixed or removable hard disk drives, flash memory devices, and CD-ROM (compact disc read-only-memory), DVD-ROM (digital versatile disc-ROM), Blu-ray, or other magnetic, optical, or solid state storage devices.

The peripheral bus 138 may be coupled to low-bandwidth clients. For example, the input device(s) 128 coupled to the peripheral bus 138 may include touch screen devices, keyboard devices, sensor devices, etc. that are configured to receive information (e.g., user input information, location information, orientation information, etc.). The input device(s) 128 may be coupled to the peripheral bus 138 via a serial peripheral interface (SPI), inter-integrated circuit (I2C), and the like.

In various embodiments, system bus 132 may include an AMBA High-performance Bus (AHB), and peripheral bus 138 may include an Advanced Peripheral Bus (APB). Additionally, in other embodiments, any device described above may be coupled to either of the system bus 132 or peripheral bus 138, depending on the bandwidth requirements, latency requirements, etc. of the device. For example, multi-media card controllers may be coupled to the peripheral bus 138.

A camera (not shown) may be coupled to the camera processor 120. The camera processor 120 includes an interface, such as a MIPI® camera serial interface (CSI). The camera processor 120 may further include an encoder preprocessor (EPP) and an image signal processor (ISP) configured to process images received from the camera. The camera processor 120 may further be configured to forward processed and/or unprocessed images to the display controller 111 via the system bus 132. In addition, the system bus 132 and/or the command interface 134 may be configured to receive information, such as synchronization signals, from the display controller 111 and forward the information to the camera.

In some embodiments, GPU 112 is part of a graphics subsystem that renders pixels for a display device 110 that may be any conventional cathode ray tube, liquid crystal display, light-emitting diode display, or the like. In such embodiments, the GPU 112 and/or display controller 111 incorporates circuitry optimized for graphics and video processing, including, for example, video output circuitry such as a high-definition multimedia interface (HDMI) controller, a MIPI® display serial interface (DSI) controller, and the like. In other embodiments, the GPU 112 incorporates circuitry optimized for general purpose and/or compute processing. Such circuitry may be incorporated across one or more general processing clusters (GPCs) included within GPU 112 that are configured to perform such general purpose and/or compute operations. System memory 104 includes at least one device driver 103 configured to manage the processing operations of the GPU 112. System memory 104 also includes a field of view engine 140 configured to receive information from a camera and/or an input device 128, such as a gyroscope, accelerometer, or other type of sensor. The field of view engine 140 then computes field of view information, such as a field of view vector, a two-dimensional transform, a scaling factor, or a motion vector. The field of view information may then be forwarded to the display controller 111, camera processor 120, and/or to an input device 128.

In various embodiments, GPU 112 may be integrated with one or more of the other elements of FIG. 1 to form a single hardware block For example, GPU 112 may be integrated with the display controller 111, camera processor 120, video encoder/decoder, audio device 126, and/or other connection circuitry included in the computer system 100.

It will be appreciated that the system shown herein is illustrative and that variations and modifications are possible. The connection topology, including the number and arrangement of buses, the number of CPUs 102, and the number of GPUs 112, may be modified as desired. For example, the system may implement multiple GPUs 112 having different numbers of processing cores, different architectures, and/or different amounts of memory. In implementations where multiple GPUs 112 are present, those GPUs may be operated in parallel to process data at a higher throughput than is possible with a single GPU 112. Systems incorporating one or more GPUs 112 may be implemented in a variety of configurations and form factors, including, without limitation, desktops, laptops, handheld personal computers or other handheld devices, servers, workstations, game consoles, embedded systems, and the like. In some embodiments, the CPUs 102 may include one or more high-performance cores and one or more low-power cores. In addition, the CPUs 102 may include a dedicated boot processor that communicates with internal memory 106 to retrieve and execute boot code when the computer system 100 is powered on or resumed from a low-power mode. The boot processor may also perform low-power audio operations, video processing, math functions, system management operations, etc.

In various embodiments, the computer system 100 may be implemented as a system on chip (SoC). In some embodiments, CPU(s) 102 may be connected to the system bus 132 and/or the peripheral bus 138 via one or more switches or bridges (not shown). In still other embodiments, the system bus 132 and the peripheral bus 138 may be integrated into a single bus instead of existing as one or more discrete buses. Lastly, in certain embodiments, one or more components shown in FIG. 1 may not be present. For example, I/O controller(s) 124 may be eliminated, and the storage device 114 may be a managed storage device that connects directly to the system bus 132. Again, the foregoing is simply one example modification that may be made to computer system 100. Other aspects and elements may be added to or removed from computer system 100 in various implementations, and persons skilled in the art will understand that the description of FIG. 1 is exemplary in nature and is not intended in any way to limit the scope of the present invention.

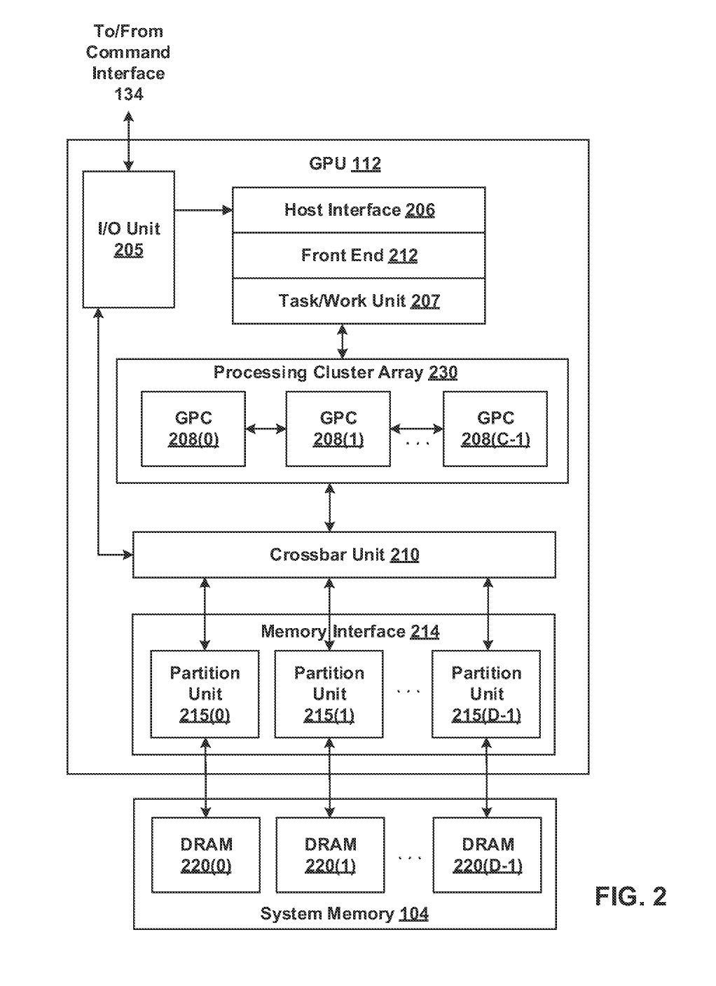

FIG. 2 is a block diagram of the GPU 112 of FIG. 1, according to one embodiment of the present invention. Although FIG. 2 depicts one GPU 112 having a particular architecture, any technically feasible GPU architecture falls within the scope of the present invention. Further, as indicated above, the computer system 100 may include any number of GPUs 112 having similar or different architectures. GPU 112 may be implemented using one or more integrated circuit devices, such as one or more programmable processor cores, application specific integrated circuits (ASICs), or memory devices. In implementations where system 100 comprises an SoC, GPU 112 may be integrated within that SoC architecture or in any other technically feasible fashion.

In some embodiments, GPU 112 may be configured to implement a two-dimensional (2D) and/or three-dimensional (3D) graphics rendering pipeline to perform various operations related to generating pixel data based on graphics data supplied by CPU(s) 102 and/or system memory 104. In other embodiments, 2D graphics rendering and 3D graphics rendering are performed by separate GPUs 112. When processing graphics data, one or more DRAMs 220 within system memory 104 can be used as graphics memory that stores one or more conventional frame buffers and, if needed, one or more other render targets as well. Among other things, the DRAMs 220 within system memory 104 may be used to store and update pixel data and deliver final pixel data or display frames to display device 110 for display. In some embodiments, GPU 112 also may be configured for general-purpose processing and compute operations.

In operation, the CPU(s) 102 are the master processor(s) of computer system 100, controlling and coordinating operations of other system components. In particular, the CPU(s) 102 issue commands that control the operation of GPU 112. In some embodiments, the CPU(s) 102 write streams of commands for GPU 112 to a data structure (not explicitly shown in either FIG. 1 or FIG. 2) that may be located in system memory 104 or another storage location accessible to both CPU 102 and GPU 112. A pointer to the data structure is written to a pushbuffer to initiate processing of the stream of commands in the data structure. The GPU 112 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, GPU 112 includes an I/O (input/output) unit 205 that communicates with the rest of computer system 100 via the command interface 134 and system bus 132. I/O unit 205 generates packets (or other signals) for transmission via command interface 134 and/or system bus 132 and also receives incoming packets (or other signals) from command interface 134 and/or system bus 132, directing the incoming packets to appropriate components of GPU 112. For example, commands related to processing tasks may be directed to a host interface 206, while commands related to memory operations (e.g., reading from or writing to system memory 104) may be directed to a crossbar unit 210. Host interface 206 reads each pushbuffer and transmits the command stream stored in the pushbuffer to a front end 212.

As mentioned above in conjunction with FIG. 1, how GPU 112 is connected to or integrated with the rest of computer system 100 may vary. For example, GPU 112 can be integrated within a single-chip architecture via a bus and/or bridge, such as system bus 132. In other implementations, GPU 112 may be included on an add-in card that can be inserted into an expansion slot of computer system 100.

During operation, in some embodiments, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

In various embodiments, GPU 112 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 may include a set of D of partition units 215, where D≧1. Each partition unit 215 is coupled to the one or more dynamic random access memories (DRAMs) 220 residing within system memory 104. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. As previously indicated herein, in operation, various render targets, such as texture maps and frame buffers, may be stored across DRAMs 220, allowing partition units 215 to write portions of each render target in parallel to efficiently use the available bandwidth of system memory 104.

A given GPC 208 may process data to be written to any of the DRAMs 220 within system memory 104. Crossbar unit 210 is configured to route the output of each GPC 208 to any other GPC 208 for further processing. Further GPCs 208 are configured to communicate via crossbar unit 210 to read data from or write data to different DRAMs 220 within system memory 104. In one embodiment, crossbar unit 210 has a connection to I/O unit 205, in addition to a connection to system memory 104, thereby enabling the processing cores within the different GPCs 208 to communicate with system memory 104 or other memory not local to GPU 112. In the embodiment of FIG. 2, crossbar unit 210 is directly connected with I/O unit 205. In various embodiments, crossbar unit 210 may use virtual channels to separate traffic streams between the GPCs 208 and partition units 215.

Although not shown in FIG. 2, persons skilled in the art will understand that each partition unit 215 within memory interface 214 has an associated memory controller (or similar logic) that manages the interactions between GPU 112 and the different DRAMs 220 within system memory 104. In particular, these memory controllers coordinate how data processed by the GPCs 208 is written to or read from the different DRAMs 220. The memory controllers may be implemented in different ways in different embodiments. For example, in one embodiment, each partition unit 215 within memory interface 214 may include an associated memory controller. In other embodiments, the memory controllers and related functional aspects of the respective partition units 215 may be implemented as part of memory controller 136. In yet other embodiments, the functionality of the memory controllers may be distributed between the partition units 215 within memory interface 214 and memory controller 136.

In addition, in certain embodiments that implement virtual memory, CPUs 102 and GPU(s) 112 have separate memory management units and separate page tables. In such embodiments, arbitration logic is configured to arbitrate memory access requests across the DRAMs 220 to provide access to the DRAMs 220 to both the CPUs 102 and the GPU(s) 112. In other embodiments, CPUs 102 and GPU(s) 112 may share one or more memory management units and one or more page tables.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, GPU 112 is configured to transfer data from system memory 104, process the data, and write result data back to system memory 104. The result data may then be accessed by other system components, including CPU 102, another GPU 112, or another processor, controller, etc. within computer system 100.

### Generating a Low-Latency Transparency Effect

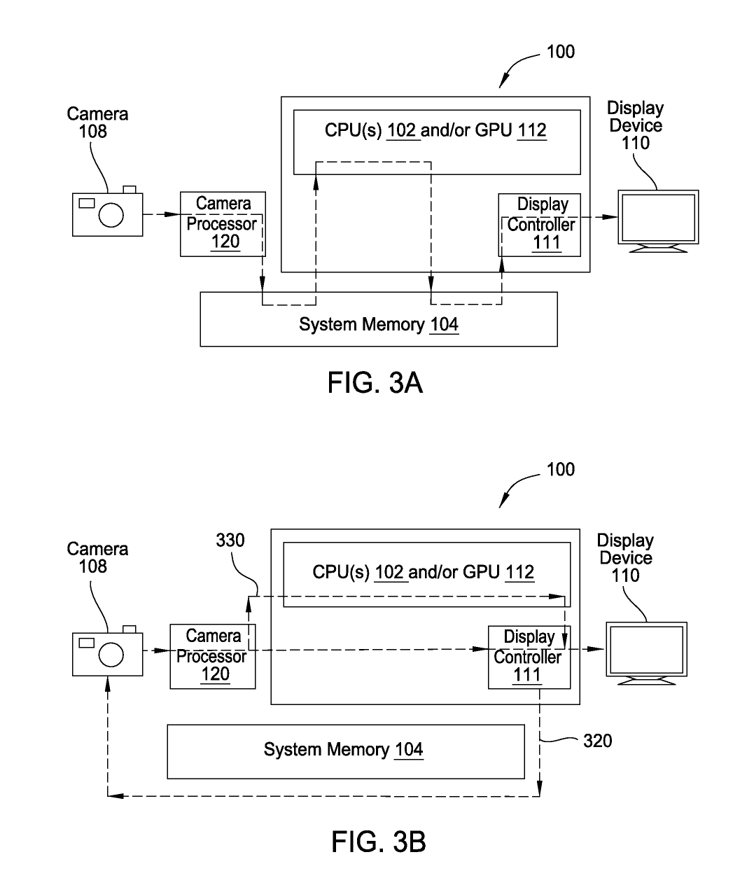

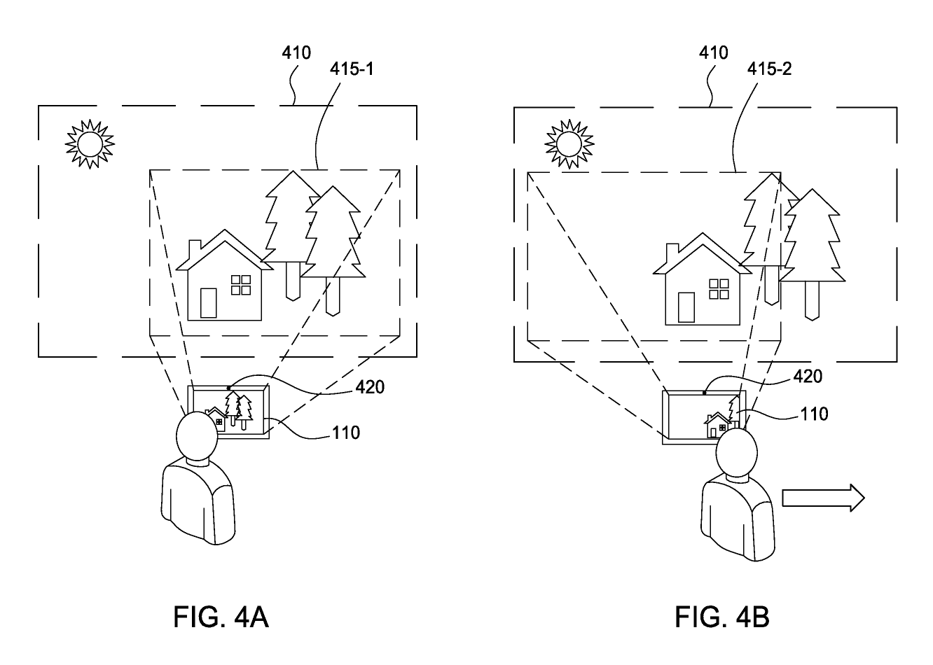

FIG. 3A illustrates a conventional technique for processing an image acquired by a camera 108. As shown, after an image is acquired by the camera 108, the image is passed between a number of memory devices and processing devices included in the computer system 100. For example, the image is passed from the camera 108 to a camera processor 120 included in a camera pipeline. The camera processor 120 may apply color correction and/or color space conversion to the image. The camera processor 120 then stores the image in system memory 104. Next, the CPU 102 retrieves the image from system memory 104 and performs additional processing on the image and/or passes the image to the GPU 112. The GPU 112 stores to the system memory 104 and may composite information over the image. Finally, the GPU 112 passes the image to the display controller 111, which may perform additional color conversion on the image and display the image on the display device 110.

Passing an image acquired by the camera 108 between the memory devices and processing devices described above may result in significant delay between the time at which the image is acquired by the camera 108 and the time at which the image is displayed to the user. In conventional electronic devices, this latency may be on the order of 100 milliseconds or more. As a result, conventional image processing techniques are poorly suited for generating a transparency effect, which generally requires displaying images acquired by the camera substantially in real-time (e.g., with one frame of latency or less).

FIG. 3B illustrates a technique for processing an image acquired by a camera to generate a transparency effect, according to one embodiment of the present invention. In various embodiments, in order to reduce the delay between the time at which an image is acquired by the camera 108 and the time at which the image is displayed on the display device 110, the camera 108 may be synchronized with the display device 110. Synchronizing the camera 108 and the display device 110 enables the camera 108 to output images directly to the display controller 111, as soon as the images are acquired, at a rate that is compatible with a refresh rate of the display device 110.

Upon receiving each image, the display controller 111 may apply scaling transformation, and/or clipping, composite the image with visual information, such as a graphical user interface (GUI), and display the resulting image on the display device 110. In various embodiments, acquiring the image, processing of the image (e.g., via scaling, transformation, clipping, and/or compositing), and displaying the image is performed within a period of time associated with refreshing one display frame on the display. That is, each image acquired by the camera 108 may be transmitted to the display controller 111, transformed, composited, and displayed on the display device 110 within a period of time associated with refreshing a display frame on the display device 110. For example, if the display device 110 has a vertical refresh rate of 60 Hz, then the difference between the time at which the image is acquired and the time at which the image is displayed, including processing of the image, would be equal to or less than 1/60^{th} of a second. In another example, if the display device 110 has a vertical refresh rate of 50 Hz, 30 Hz, or 24 Hz, then the difference between the time at which the image is acquired and the time at which the image is displayed, including processing of the image, would be equal to or less than 1/50^{th} of a second, 1/30^{th} of a second, or 1/24^{th} of a second, respectively.

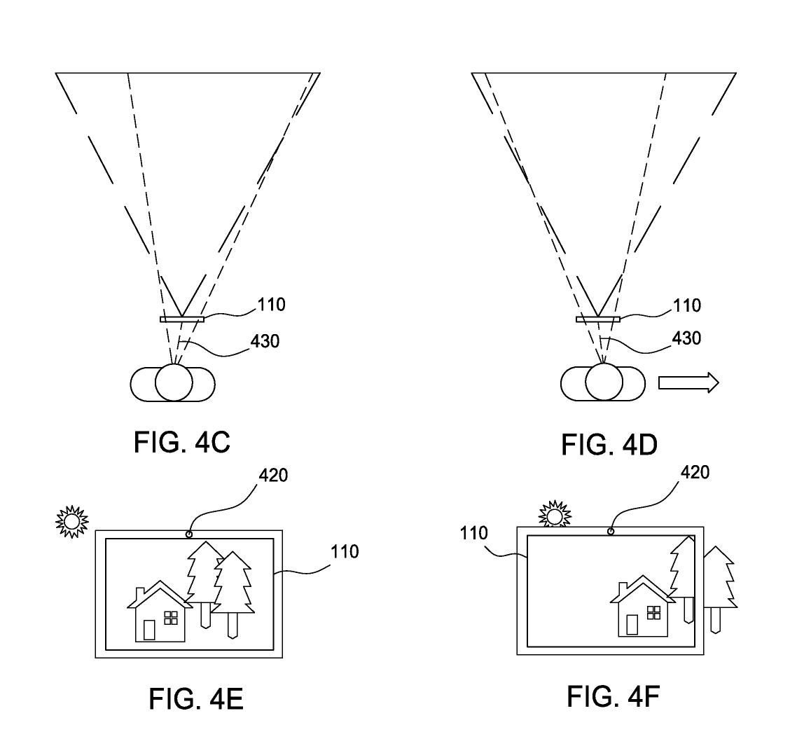

Synchronizing the camera 108 to the display device 110 may be achieved in a variety of ways. For example, in various embodiments, a synchronization signal 320 is transmitted from the display controller 111 to the camera 108 and/or camera processor 120. The camera 108 and display device 110 may then be generator-locked based on the synchronization signal 320. The synchronization signal 320 may be based on one or more refresh rates of the display device 110, such as a vertical refresh rate and/or a horizontal refresh rate. If the synchronization signal 320 is based on the vertical refresh rate of the display device 110, then the camera 108 may be configured to output one image for each vertical refresh performed by the display device 110. For example, if the vertical refresh rate of the display device 110 was 60 Hz, then the camera 108 would acquire and output 60 images-per-second to the display controller 111. Alternatively, in order to reduce processing requirements, the number of images-per-second acquired and outputted by the camera 108 could be an integer multiple of the vertical refresh rate of the display device 110. For example, if the vertical refresh rate of the display device 110 was 60 Hz, then the camera 108 could acquire and output 15 images-per-second, 20 images-per-second, or 30 images-per-second. In such embodiments, each image outputted by the camera 108 could be used to display more than one frame on the display device 110, such as by performing image interpolation and/or by processing and displaying a different portion of a given image during each vertical refresh period, as described in further detail below in conjunction with FIGS. 4A-4F.

If the synchronization signal 320 is based on the horizontal refresh rate of the display device 110, then the camera 108 may be configured to output one image line (e.g., one scan line) for each horizontal display line refreshed by the display device 110. For example, the camera 108 may be configured to acquire and output image lines in a line-by-line manner, ahead of the horizontal refresh of the display device 110, directly to the display controller 111 at a rate that is substantially similar to the rate at which horizontal display lines are refreshed by the display device 110. Accordingly, a raster-chasing type of functionality may be utilized so that the correct images lines are transmitted directly to the display controller 111 with little buffering. In other embodiments, the camera 108 may be configured to acquire and output image lines in a line-by-line manner directly to the display controller 111 at a rate that is an integer multiple of the rate at which horizontal display lines are refreshed by the display device 110. Additionally, in some embodiments, the synchronization signal 320 may be based on both the horizontal refresh rate and the vertical refresh rate of the display device 110. In such embodiments, the camera 108 may be configured to acquire and output each image in a line-by-line manner directly to the display controller 111 at a rate that is substantially similar to (or an integer multiple of) the rate at which horizontal display lines are refreshed by the display device 110, and the number of images transmitted to the display controller 111 may be equal to (or an integer multiple of) the vertical refresh rate.

In various embodiments, the synchronization signal 320 may be used to synchronize only a portion of the image frame acquired by the camera 108 to the display device 110. For example, the display device 110 may be generator-locked to a portion of the image acquired by the camera 108 such that only that portion of the image is outputted to the display controller 111. In such embodiments, the portion of the camera 108 image to which the display device 110 is generator-locked may be scanned out to the display controller 111 in a line-by-line manner (e.g., based on the horizontal refresh rate of the display device 110) or the portion of the camera 108 image may be outputted to the display controller 111 in a frame-by-frame manner (e.g., based on the vertical refresh rate of the display device 110).

The display controller 111 may include the capability to composite real-time images received from the camera 108 with non-real-time images and visual information, such as a GUI and computer graphics generated by the GPU 112. Although the camera processor 120 and the display controller 111 are illustrated as modules that are separate from the camera 108 and the display device 110, the camera processor 120 and the display controller 111 may be modules that are included in the camera 108 and display device 110, respectively. In addition, processing described herein as being performed by the display controller 111 (e.g., transformations) may be performed by the camera processor 120, and processing described herein as being performed by the camera processor 120 (e.g., color correction) may be performed by the display controller 111. Furthermore, the camera processor 120 and the display controller 111 may be included in a single module. For example, in one embodiment, the camera 108 could output unprocessed image data directly to the display controller 111, which then could perform color correction, color conversion, scaling, transformation, clipping, and/or compositing operations. Additionally, image data acquired by the camera 108 and/or processed by the camera processor 120 may be transmitted to the CPU(s) 102 and/or GPU 112 via optional parallel path 330. Once received by the CPU(s) 102 and/or GPU 112, the image data may be processed to generate non-real-time data, such as augmented reality information, that may be transmitted to the display controller 111. The non-real-time data may then be added to the overlay of the real-time images received from the camera 108.

FIGS. 4A-4F are conceptual diagrams of transparency effects produced by the technique of FIG. 3B, according to various embodiments of the present invention. As shown, as the position of the user changes with respect to the position of the display device 110, the image displayed on the display device 110 is updated so that the display device 110 appears transparent from the point of view of the user, as shown in FIGS. 4E and 4F. In various embodiments, the display device 110 includes a sensor 420 that tracks the line of sight of the user. The line of sight data acquired by the sensor 420 is then used to determine how images received from the camera 108 should be scaled, transformed, and/or clipped for display on the display device 110. For example, the line of sight data may include a line of sight vector 430 that specifies the offset of the user's line of sight from the center of the display device 110, which may be defined as the origin of an x,y-coordinate system, as well as the distance from the user's eyes to the display device 110, which may be defined as the z-dimension of the line of sight vector 430. The line of sight data may further include information indicating the angle of the user's eyes relative to a surface of the display device 110.

In some embodiments, the sensor 420 acquires line of sight data based on facial recognition techniques known to those of skill in the art. For example, the sensor 420 may be a low-power image sensor that captures images of the user's face and processes the images to determine line of sight data, or passes the images to a secondary processor (e.g., the display controller 111, camera processor 120, CPU 102, GPU 112, etc.). In other embodiments, other types of sensors may be used to determine a user's line of sight.

Once the line of sight data has been acquired by the sensor 420, the data is used to determine how the image 410 received from the camera 108 is to be scaled, transformed, and/or clipped so that the display device 110 appears transparent from the point of view of the user. For example, if the line of sight data (e.g., line of sight vector 430) indicates that the user's line of sight is to the left of the display device 110, then the image 410 acquired by the camera 108 may be clipped such that the display device 110 displays only a first portion 415-1 of the right side of the image 410, as shown in FIGS. 4A, 4C, and 4E. Alternatively, if the line of sight data indicates that the user's line of sight is to the right of the display device 110, then the image 410 acquired by the camera 108 may be clipped such that the display device 110 displays only a second portion 415-2 of the left side of the image 410, as shown in FIGS. 4B, 4D and 4F. Similar techniques may be applied if the line of sight data indicates that the user's line of sight is above or below the display device 110. Further, if the line of sight data indicates that the user's line of sight has moved closer to (or further from) the display device 110, then the image 410 acquired by the camera 108 may be scaled such that a larger (or smaller) portion 415 of the image 410 is displayed on the display device 110. Additionally, a transform may be computed based on the line of sight data and applied to the image 410 or the portion 415 of the image 410 so that the display device 110 appears transparent to the user. For example, if the line of sight vector 430 indicates that the user is off-axis relative to the center of the display device 110, then a transform may be applied to skew the portion 415 of the image 410. By applying a transform in this manner, an image having the correct perspective, relative to the user's line of sight, is displayed on the display device 110. A transform may be applied to an image 410 or portion 415 of an image 410 using texture map techniques known to those of skill in the art.

A single image 410 acquired by the camera 108 may be used for more than one frame displayed by the display device 110. For example, different portions 415 of the same image 410 may be clipped and used in different frames displayed by the display device 110 to generate the transparency effect. Accordingly, in various embodiments, the camera 108 may include a wide-angle lens in order to capture a larger view of the user's surroundings. By using an image 410 captured by the camera 108 more than once, the rate at which images are acquired by the camera 108 may be less than vertical refresh rate of the display device 110, reducing processing requirements and power consumption.

In other embodiments, the line of sight data acquired by the sensor 420 may be used to perform camera tilting techniques. In camera tilting techniques, the camera 108 is rotated to change the angle of the camera 108 relative to the display device 110. Thus, instead of capturing only what is directly in front of the display device 110, the camera 108 may be rotated to acquire images that are off-axis relative to the display device 110. For example, with respect to FIGS. 4A, 4C and 4E, if the line of sight data indicates that the user's line of sight is to the left of the display device 110, then the camera 108 could be rotated to the right relative to the display device 110. As a result, the image 410 acquired by the camera 108 would capture more of the user's surroundings to the right of the display device 110. Alternatively, with respect to FIGS. 4B, 4D and 4F, if the line of sight data indicates that the user's line of sight is to the right of the display device 110, then the camera 108 could be rotated to the left relative to the display device 110. As a result, the image 410 acquired by the camera 108 would capture more of the user's surroundings to the left of the display device 110. Similar camera tilting techniques may be applied if the line of sight data indicates that the user's line of sight is above or below the display device 110. Further, if the line of sight data indicates that the user's line of sight has moved closer to (or further from) the display device 110, then the camera 108 could zoom in on (or zoom out from) the user's surroundings to capture an appropriate image 410 based on the user's perspective. By using the camera tilting techniques described above, the amount of processing performed on images 410 acquired by the camera 108 may be reduced. For example, rotating the camera 108 to match the line of sight of the user may reduce or eliminate the need to apply a transform 410, such as a skew, to images acquired by the camera 108.

In addition to determining a line of sight vector 430, the sensor 420 and/or other types of sensors (e.g., a gyroscope, compass, and/or accelerometer) may be used to determine a motion vector that represents actual or predicted movement of the line of sight of the user relative to the display device 110. Movement of the line of sight of the user relative to the display device 110 may include movement of the user's eyes and/or movement of the display device 110. Once a motion vector is computed, the motion vector may be used to perform motion estimation and image prefetching using the image scaling/transform/clipping and/or camera titling techniques described above. For example, if a motion vector indicates that the line of sight of the user is moving to the right relative to the display device 110, then the portion 415 of the same image 410 (or a subsequent image 410) may be clipped such that the display device 110 displays more of the left side of the image 410. As described above, clipping different portions 415 of the same image 410 for display in consecutive frames on the display device 110 may enable the display device to be updated more quickly than the rate at which images 410 are acquired by the camera 108. Accordingly, the display device 110 can produce an accurate transparency effect even when the motion vector indicates that the position of the user's line of sight is moving at a high speed relative to the display device 110. In addition, if a motion vector indicates that the line of sight of the user is moving to the right relative to the display device 110, then the camera 108 could be rotated to the left relative to the display device 110 to capture more of the user's surroundings to the left of the display device 110.

In some embodiments, the camera 108 and/or the other types of sensors describe above may be used to determine a motion vector that represents actual or predicted movement of the display device 110 relative to the surrounding environment. For example, if the user is walking with the display device 110 and turning a corner, the motion vector may be used to determine which portion 415 of the image 410 should be clipped or to determine that the camera should be tilted to prefetch images for display. In addition, the resolution at which images 410 are acquired by the camera 108 may be varied based on the motion vector. For example, when the motion vector indicates that the camera 108 is static or moving slowly with respect to the surroundings, higher resolution images (or higher quality) may be acquired at a slower frame rate. Alternatively, when the motion vector indicates that the camera 108 is moving quickly with respect to the surroundings, lower resolution (or lower quality) images may be acquired at a higher frame rate, enabling the display device 110 to accurately produce the transparency effect when the camera is being moved at high speeds. Thus, using the camera 108 and/or other sensors to compute a motion vector may enable the display device 110 to more accurately produce the transparency effect even when the user is moving quickly, such that the image displayed on the display device 110 must be updated more quickly than the rate at which images 410 are acquired by the camera 108.

In order to reduce visual artifacts produced when capturing images of an external display that is located in the user's surroundings, the camera 108 may be generator-locked to the external display. In such embodiments, the camera 108 may be used to determine the vertical and/or horizontal refresh rates of the external display. The camera 108 then may be synchronized to the refresh rate(s) of the external display. Consequently, visible artifacts (e.g., “screen flicker”) produced when displaying images of the external display on the display device 110 may be reduced or eliminated.

The computations required to determine the line of sight vector 430, scaling factor, transform, clipping parameters, external display refresh rates, etc. may be performed in the display controller 111 and/or camera processor 120. Alternatively, such computations may be performed by a line of sight engine stored in the system memory 104 using the CPU 102 or the GPU 112. In some embodiments, these computations are performed by a dedicated processor (e.g., an application-specific integrated circuit (ASIC)) included in the display controller 111, camera processor 310, and/or in a processor associated with the sensor 420.

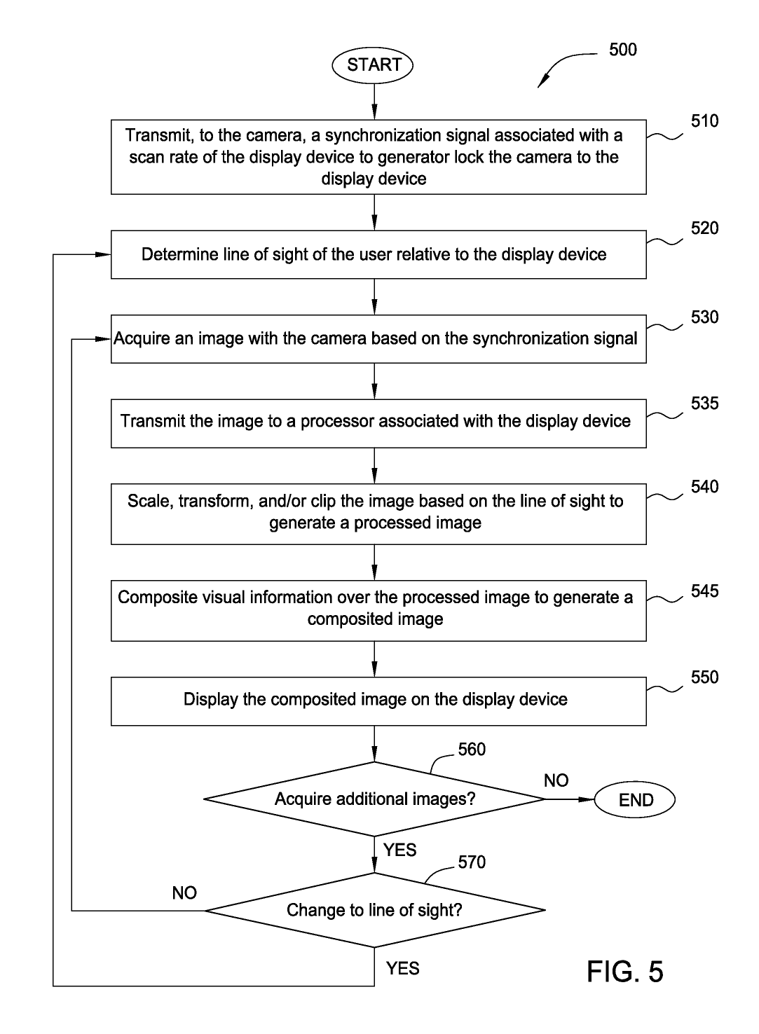

FIG. 5 is a flow diagram of method steps for generating a transparency effect for a computing device, according to one embodiment of the present invention. Although the method steps are described in conjunction with the systems of FIGS. 1-4F, persons skilled in the art will understand that any system configured to perform the method steps, in any order, falls within the scope of the present invention.

As shown, a method 500 begins at step 510, where the display controller 111 or the display device 110 transmits a synchronization signal 320 associated with a refresh rate of the display device 110 to the camera 108. In some embodiments, the camera 108 is then generator-locked to the display device 110 based on the synchronization signal 320. At step 520, the sensor 420 determines the line of sight of the user relative to the display device 110. In other embodiments, at step 520, the sensor 420 acquires sensor data, such as an image, and transmits the sensor data to a secondary processor (e.g., the display controller 111, camera processor 310, CPU 102, GPU 112, etc.). The secondary processor then processes the sensor data to determine the line of sight of the user relative to the display device 110.

Next, at step 530, the camera 108 acquires an image based on the synchronization signal 320. At step 535, the image is transmitted to the display controller 111. At step 540, the display controller 111 scales, transforms, and/or clips the image based on the line of sight of the user relative to the display device 110 to generate a processed image. In other embodiments, scaling, transformation, and/or clipping operations may be performed by another processor, such as the camera processor 310. In still other embodiments, no scaling, transformation, and/or clipping operations are performed on the image, and images acquired by the camera 108 are displayed from the perspective of the display device 110, not the user.

At step 545, the display controller 111 composites visual information, such as a GUI, over the processed image to generate a composited image. Then, at step 550, the display device 110 displays the composited image to the user. At step 560, the display controller 111 determines whether additional images are to be acquired and displayed. If no additional images are to be acquired, then the method 500 ends. If additional images are to be acquired, then the method 500 proceeds to step 570, where the display controller 111 determines whether the line of sight of the user relative to the display device 110 has changed. If the line of the sight of the user relative to the display device 110 has changed, then the method 500 returns to step 520, where the sensor 420 or a secondary processor determines an updated line of sight of the user relative to the display device 110. If the line of the sight of the user relative to the display device 110 has not changed, then the method 500 returns to step 530, where the camera acquires an additional image based on the synchronization signal 320.

In sum, a synchronization signal associated with a refresh rate of a display device is transmitted to a camera. The camera then captures a series of images based on the synchronization signal. As each image is acquired by the camera, the image is transmitted to a buffer memory, where visual information is composited over the image. The composited image is then displayed by the display device. Optionally, a sensor may detect a line of sight of a user that is viewing the display device, and, prior to displaying an image, scaling, a transform, and/or clipping may be applied to the image. Additionally, the sensor may detect a change to the line of sight of the user relative to the display device. In response, an updated scaling factor, transformation, and/or clipping parameters may be computed and applied to one or more subsequent images acquired by the camera.

One advantage of the techniques described herein is that a display device can be configured to simulate a transparency effect in real-time. The transparency effect may be modified based on changes to the position of the user relative to the display device to provide the user with a continuous line of sight through the display device. Accordingly, the user is able to more efficiently view information on the display device while also viewing and interacting with objects that would otherwise be obscured by the display device.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A computer-implemented method for generating a transparency effect for a computing device, the method comprising:
transmitting, to a camera, a synchronization signal associated with a refresh rate of a display;
determining a line of sight of a user relative to the display;
acquiring a first image based on the synchronization signal;
processing the first image based on the line of sight of the user to generate a first processed image;
compositing first visual information and the first processed image to generate a first composited image; and
displaying the first composited image on the display.

2. The method of claim 1, further comprising generator-locking the camera to the display based on the synchronization signal, wherein acquiring the first image, processing the first image, compositing the first visual information, and displaying the first composited image are performed within a period of time associated with refreshing a display frame on the display.

3. The method of claim 1, wherein processing the first image comprises projecting a line of sight of the user through a surface of the display to determine a first transform, and applying the first transform to the first image.

4. The method of claim 3, further comprising:
detecting a change in a position of the user relative to the display;
determining an updated line of sight of the user relative to the display;
acquiring a second image with the camera based on the synchronization signal;
applying a second transform to the second image to generate a second processed image, wherein the second transform is based on a projection of the updated line of sight of the user through the surface of the display;
compositing second visual information and the second processed image to generate a second composited image; and
displaying the second composited image on the display.

5. The method of claim 1, wherein processing the first image comprises clipping and scaling the first image.

6. The method of claim 1, further comprising:
detecting a change in a position of the user relative to the display;
determining an updated line of sight of the user relative to the display;
rotating, relative to the display, a lens associated with the camera based on the updated line of sight of the user;
after rotating the lens, acquiring a second image with the camera based on the synchronization signal;
compositing second visual information and the second image to generate a second composited image; and
displaying the second composited image on the display.

7. The method of claim 6, wherein rotating the lens comprises computing a motion vector based on the change in the position of the user.

8. The method of claim 1, further comprising:
detecting a change in a position of the display relative to a surrounding environment;
computing a motion vector based on the change in the position of the display;
adjusting an image acquisition resolution based on the motion vector;
acquiring a second image with the camera based on the image acquisition resolution;
compositing second visual information and the second image to generate a second composited image; and
displaying the second composited image on the display.

9. The method of claim 1, wherein the line of sight of a user relative to the display is determined by tracking an eye position of the user.

10. The method of claim 1, wherein the refresh rate comprises a horizontal refresh rate associated with the display.

11. The method of claim 10, wherein acquiring the first image with the camera comprises scanning out, based on the horizontal refresh rate, at least one line of the first image from the camera directly to a buffer memory associated with the display.

12. A computing device, comprising:
a processor configured to:
transmit, to a camera, a synchronization signal associated with a refresh rate of a display;
determine a line of sight of a user relative to the display;
process a first image based on the line of sight of the user to generate a first processed image; and
composite first visual information and the first processed image to generate a first composited image;
the camera, configured to acquire the first image based on the synchronization signal; and
the display, configured to display the first composited image.

13. The computing device of claim 12, wherein the camera is further configured to generator-lock to the display based on the synchronization signal, wherein acquiring the first image, processing the first image, compositing the first visual information, and displaying the first composited image are performed within a period of time associated with refreshing a display frame on the display.

14. The computing device of claim 12, wherein the processor is configured to process the first image by projecting a line of sight of the user through a surface of the display to determine a first transform, and applying the first transform to the first image.

15. The computing device of claim 14, wherein:
the processor is further configured to:
detect a change in a position of the user relative to the display;
determine an updated line of sight of the user relative to the display;
apply a second transform to a second image to generate a second processed image, wherein the second transform is based on a projection of the updated line of sight of the user through the surface of the display; and
composite second visual information and the second processed image to generate a second composited image;
the camera is further configured to acquire the second image with the camera based on the synchronization signal; and
the display is further configured to display the second composited image.

16. The computing device of claim 12, wherein processing the first image comprises clipping and scaling the first image.

17. The computing device of claim 12, wherein:
the processor is further configured to:
detect a change in a position of the user relative to the display;
determine an updated line of sight of the user relative to the display;
rotate, relative to the display, a lens associated with the camera based on the updated line of sight of the user; and
composite second visual information and a second image to generate a second composited image;
the camera is further configured to, after the processor rotates the lens, acquire the second image with the camera based on the synchronization signal; and
the display is further configured to display the second composited image.

18. The computing device of claim 17, wherein the processor is configured to rotate the lens by computing a motion vector based on the change in the position of the user.

19. The computing device of claim 12, wherein the refresh rate comprises a horizontal refresh rate associated with the display.

20. The computing device of claim 19, wherein the camera is configured to acquire the first image by scanning out, based on the horizontal refresh rate, at least one line of the first image from the camera directly to a buffer memory associated with the display.

21. A non-transitory computer-readable storage medium including instructions that, when executed by a processing unit, cause the processing unit to generate a transparency effect for a computing device, by performing the steps of:
transmitting, to a camera, a synchronization signal associated with a refresh rate of a display;
determining a line of sight of a user relative to the display;
acquiring a first image based on the synchronization signal;
processing the first image based on the line of sight of the user to generate a first processed image;
compositing first visual information and the first processed image to generate a first composited image; and
displaying the first composited image on the display.
